(19) United States
(12) Patent Application Publication
(10) Pub. No.: US 2011/0117932 A1
(43) Pub. Date: May 19, 2011

(54) METHOD FOR CHECKING THE LOCATION OF A FEMTOCELL

(75) Inventors: Markus Breitbach, Bonn (DE); Matthias Roebke, Cologne (DE)

(73) Assignee: DEUTSCHE TELEKOM AG, Bonn (DE)

(21) Appl. No.: 13/054,515

(22) PCT Filed: May 19, 2010
(86) PCT No.: PCT/DE10/75041

§ 371 Date: Jan. 17, 2011

(30) Foreign Application Priority Data
May 20, 2009 (DE) 10 2009 025 851.5

(51) Int. Cl. H04W 4/00

(52) U.S. Cl. 455/456.1

(57) ABSTRACT

A method for checking the location of a femtocell includes receiving, by the femtocell and by a reference receiver having a known location, radio signals from at least three transmitters disposed at known locations. Each of the transmitters is at least one of a broadcast transmitter and a pilot radio signal transmitter configured to broadcast a pilot radio signal for checking the location of the femtocell in a frequency range outside frequency ranges used for mobile communication. Differences in delay of the radio signals from two of the at least three transmitters are determined based on reception times of the radio signals received by the femtocell and the reference receiver. The location of the femtocell is checked based on the determined differences in delay.

### CROSS-REFERENCE TO PRIOR APPLICATIONS

This application is a U.S. National Phase application under 35 U.S.C. §371 of International Application No. PCT/DE2010/075041, filed on May 19, 2010, and claims benefit to German Patent Application No. DE 10 2009 025 851.5, filed on May 20, 2009. The International Application was published in German on Nov. 25, 2010 as WO 2010/133225 under PCT Article 21(2).

### FIELD

The invention relates to a method for checking the location of a femtocell.

### BACKGROUND

In mobile communication networks of the second (GSM) and third (UMTS) generations and subsequent generations, radio cells are classically functional units which are operated by a provider of mobile communication services.

New operator concepts are changing this paradigm. By introducing very small radio cells, known as femtocells, it is conceivable that a private radio cell is operated by the customer of the mobile communication provider. The femtocell is provided by a small transmitting and receiving system, which makes mobile communication connections in the femtocell possible. Below, the term “femtocell” is equivalent to a transmitting and receiving system or femto-base station (analogous to a mobile communication base station).

A characteristic property of a femtocell is primarily determined by the emitted transmitter power, which decisively influences the size of the cell which is supplied with mobile communications. Restrictions regarding the permitted users in the cell are also possible.

A femtocell is integrated into a public mobile communication network as an addition. In particular, it is connected to the network of a mobile communication provider via a broadband network connection to the corresponding monitoring and control entities of the mobile communication operator, so that the user of mobile communication services experiences the same network quality in the area supplied by the femtocell as he or she is accustomed to from the provider's higher-level “macro-network”.

For both regulatory reasons and reasons of network economy and security, it is important that the mobile communication operator has precise knowledge of the location of the femtocell. In the case of emergency calls for example, it is also important to localise where the caller is.

One possibility for determining the location of a femtocell is to detect the surrounding macrocells of the mobile communication operator, on the identification of which an approximate position determination could be based. A method for determining the position of a mobile station on the basis of signals from base stations is described in DE 103 14 169 A1. However, this method can only be used in areas in which a radio supply via the macro-network exists. Supplying areas which are not currently supplied is thus impossible.

Another possibility is to determine the location of the femtocell by determining the physical broadband connection of the femtocell user and operator. However, this can easily be overridden by the user first directing the data streams from the femtocell to his or her home network, and onward from there into the Internet. Since the connection setup to the control and monitoring entities of the mobile communication provider then runs via the IP address of the broadband connection, the latter receives wrong or imprecise location information.

### SUMMARY

In an embodiment, the present invention provides a method for checking the location of a femtocell which includes receiving, by the femtocell and by a reference receiver having a known location, radio signals from at least three transmitters disposed at known locations. Each of the transmitters is at least one of a broadcast transmitter and a pilot radio signal transmitter configured to broadcast a pilot radio signal for checking the location of the femtocell in a frequency range outside frequency ranges used for mobile communication. Differences in delay of the radio signals from two of the at least three transmitters are determined based on reception times of the radio signals received by the femtocell and the reference receiver. The location of the femtocell is checked based on the determined differences in delay.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 is an arrangement of three transmitters at fixed, known locations, a reference receiver and a femtocell, the location of which is to be determined according to an embodiment of the invention;

FIGS. 2 and 3 show diagrams with hyperbolas, which were determined by evaluating delays and differences in delay according to an embodiment of the invention, to check the location of a femtocell; and

FIG. 4 is a flowchart of an embodiment of the method according to the invention for checking the location of a femtocell.

### DETAILED DESCRIPTION

An aspect of this invention is therefore to improve the location checking of a femtocell.

In an embodiment, the present invention checks the location of a femtocell, differences in delay of radio signals of arbitrary transmitters at known locations are determined and evaluated, it being possible to receive said radio signals at the femtocell's location and at the known location of a reference receiver. The transmitters can be broadcast transmitters or radio transmitters which broadcast special pilot radio signals with high range for location checking. The radio transmitter broadcasting the special pilot radio signals can be a transmitter which is specially provided for broadcasting these signals, or a broadcast transmitter which broadcasts the pilot radio signals in addition to traditional broadcast signals. A suitable broadcast transmitter for the purposes of this invention can be, for example, a transmitter which broadcasts analogue and/or digital broadcast signals, e.g. DVB-T or analogue broadcast signals with embedded digital RDS (radio data system) data. In this way, the location of a femtocell can be checked with relatively high precision, in particular in areas which are poorly provided with mobile communications, in particular in under-supplied areas such as in buildings, and used to activate a radio part of the femtocell for radio coverage.

An embodiment of the invention relates to a method for checking the location of a femtocell, having the following steps:

receiving radio signals from at least three transmitters at known locations by the femtocell and by a reference receiver at a known location,

determining the differences in delay of the radio signals from two of the at least three transmitters on the basis of the reception times of the radio signals received by the femtocell and the reference receiver, and checking the location of the femtocell depending on the determined differences in delay.

A transmitter can be a broadcast transmitter or a pilot radio signal transmitter broadcasting a pilot radio signal for checking the location of a femtocell in a frequency range outside the frequency ranges used for mobile communications.

In an embodiment, determining the differences in delay of the radio signals can include the following steps:

determining the reception times of the radio signals received by the femtocell and the reference receiver,

calculating time differentials on the basis of the reception times,

calculating time differences on the basis of the time differentials, and

determining the differences in delay of the radio signals from the radio transmitters to the femtocell on the basis of the time differences and of the signal delays of the radio signals from the radio transmitters to the reference receiver, said signal delays being determined on the basis of the known location of the reference receiver and the known locations of the transmitters of the radio signals.

In an embodiment, checking the location of the femtocell depending on the determined differences in delay can include the following steps in particular:

forming time differences on the basis of time differentials from the set of determined time differentials, two time differentials which are used to form a time difference being the time differentials of the reception times of the radio signals which were broadcast by the same two of the at least three transmitters and received once by the femtocell and once by the reference receiver, and

determining a distance range, associated with a formed time difference, to the transmitters, the radio signals of which were used to form the time difference, for each formed time difference, and

checking the location of the femtocell on the basis of the determined distance ranges.

In an embodiment, checking the location of the femtocell on the basis of the determined distance ranges can have the following steps:

determining an overlap area of the determined distance ranges as the area for possible locations of the femtocell, and

checking the location of the femtocell on the basis of the overlap area.

Determining the differences in delay of the radio signals from two of the at least three transmitters, and checking the location of the femtocell depending on the determined differences in delay, is done by a control and monitoring entity of a mobile communication network, time differentials which are determined on the basis of the reception times of the radio signals received by the femtocell and the reference receiver being communicated by the femtocell and the reference receiver to the control and monitoring entity for checking the location of the femtocell, and/or the local reception times of radio signals being communicated by the femtocell and the reference receiver to the control and monitoring entity. The control and monitoring entity can be operated, securely from tampering, by a mobile communication network operator, for example in the form of a special femtocell-enabling server. Furthermore, the femtocell itself does not have to carry out resource-intensive location checking.

Determining the differences in delay of the radio signals from two of the at least three transmitters, and checking the location of the femtocell depending on the determined differences in delay, can also be done by the femtocell itself, time differentials which are determined on the basis of the reception times of the radio signals received by the reference receiver being communicated by the reference receiver to the femtocell for checking the location of the femtocell, and/or reception times of the radio signals received by the reference receiver, said reference times being determined by the reference receiver, being communicated to the femtocell for checking the location of the femtocell. In this case, the femtocell can essentially take over the radio coverage autonomously, so that a mobile communication network operator does not have to keep any other infrastructure available, apart from the reference receiver if required. For example, the firmware of the femtocell can be configured to do a location check according to the invention.

Finally, determining the differences in delay of the radio signals from two of the at least three transmitters, and checking the location of the femtocell depending on the determined differences in delay, can also be done by a control and monitoring entity of a mobile communication network, the local reception times of radio signals being communicated by the femtocell and the reference receiver to the control and monitoring entity. In this case, the technical cost of implementing the method according to an embodiment of the invention in the femtocell is very small, since only the possibility of receiving the radio signals of the transmitters and measuring the reception times, and of communicating these data to the control and monitoring entity, is provided.

In an embodiment, the method can include the following steps:

determining whether the location of the femtocell corresponds to one or more planned locations of the femtocell, and

depending on that, activating provision of mobile communications by the femtocell within the area covered by the femtocell. In this way, monitoring the operation of the femtocell depending on its location is made possible, so that, as described above, tampering can be made difficult, if not largely avoided.

The mobile communication provision can be activated by the femtocell, in particular, if the location corresponds to a planned location of the femtocell, for example.

The procedure can be repeated cyclically, to make it possible to take account of changes of the location of the femtocell.

The reference receiver can be in the form of a reference femtocell, the location of which is known.

In particular, the reference femtocell can be located at a macro-base station of a mobile communication network, in particular fitted at the macro-base station.

Another embodiment of the invention includes a femtocell which is configured for use with a method according to an embodiment of the invention and as described above, and is also configured to receive radio signals from at least three transmitters at known locations.

The femtocell can also be configured to determine the differences in delay of the radio signals from two of the at least three transmitters.

In an embodiment, the femtocell can also be configured to:

transmit time differentials between reception times of received radio signals, depending on the differences in delay determined on the basis of the time differentials, to a control and monitoring entity of a mobile communication network, and/or

transmit the local reception times of radio signals, depending on the differences in delay determined on the basis of time differentials of the reception times, to a control and monitoring entity of a mobile communication network.

Furthermore, in an embodiment, the femtocell can also be configured to:

receive the reception times, measured by the reference receiver, of radio signals, to check the location of the femtocell, or the time differentials determined from them,

check its location depending on the determined differences in delay.

Finally, in an embodiment, the femtocell can also be configured to:

determine whether its location corresponds to one or more planned locations of the femtocell, and

depending on that, activate mobile communication provision by the femtocell within the area covered by the femtocell.

Furthermore, an embodiment of the invention concerns a control and monitoring entity of a mobile communication network, which is configured for use with a method according to the invention and as described above, in particular for checking the location of the femtocell and communicating to the femtocell an enabling code to activate the radio part of the femtocell, depending on the location check.

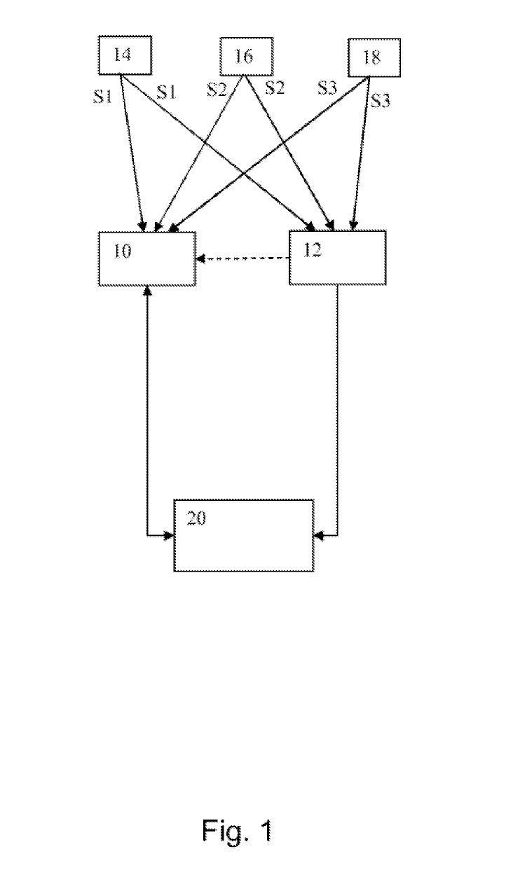

The invention is explained below with reference to an exemplary embodiment shown in FIG. 1, with three fixed radio transmitters. FIG. 1 shows a femto-base station or femtocell 10, the position of which is to be determined, and a reference receiver 12, which both receive radio signals from three radio transmitters 14, 16 and 18, which transmit from different geographical locations. The geographical locations of the three radio transmitters 14, 16 and 18 are known in principle. The location of the reference receiver 12 is also known. The radio transmitters can be broadcast transmitters or pilot radio signal transmitters which broadcast special pilot radio signals with high range for location checking, and which are provided for checking the location of femtocells. The femtocell 10 is also connected, for example via a wired broadband Internet connection, to a control and monitoring entity 20 of a mobile network operator, for communication. Via this connection, the femtocell 10 can exchange data with the control and monitoring entity 20, and in particular receive from the control and monitoring entity 20 an enabling code which enables it to activate its mobile communication provision. The reference receiver 12 can also be connected to the control and monitoring entity 20 of the mobile network operator, and/or to the femtocell 10 (dashed connection), for communication. Data communication between the femtocell 10, the reference receiver 12 and the control and monitoring entity 20 is encrypted, to avoid possible misuse, in particular to prevent tapping the enabling code.

Both the femtocell or femto-base station 10 and the reference receiver 12 determine, as described below, the reception times of radio signals, which are broadcast, in particular periodically or continuously, by the radio transmitters 14, 16 and 18. In a signal broadcast by a radio transmitter, a transmitter identifier and the transmission time, for example, can be encoded, so that a receiver can establish from which radio transmitter the received signal comes and when it was broadcast. Instead of or in addition to encoding a transmission time in a radio signal, fixed transmission times can be provided, e.g. frame structures of digital transmission signals. The frame structure of a digital signal can be used by defining a transmission time of a signal as the start of a specified frame of the frame structure, e.g. the starts of transmission frames in digital signals such as DVB-T or digital RDS data which are embedded in analogue sound radio signals. Since the receiver of the signal must synchronise itself onto the frame structure, it can also detect the start of a transmission frame and a specified frame which defines the transmission time, and determine the reception time by reading its clock. As a specified frame which defines the transmission time, for example a synchronisation frame can be used. For the synchronisation process, known as “transmission parameter signalling (TPS) pilots”, which can be evaluated to determine the reception time, are provided in a DVB-T signal. For synchronisation in the case of RDS data, a method is described in EP 0 652 660 B1, which is hereby incorporated by reference herein. The time intervals of the specified transmission times can be calculated so that the longest radio signal delay is shorter than the shortest specified transmission time interval.

For determining the delays of radio signals from the radio transmitters to the femto-base station 10 and reference receiver 12, these have clocks, which ideally run almost synchronously with the radio transmitter clocks, which are used for the transmission times which are encoded in the radio signals. For example, the clocks can be implemented by radio clocks, and/or synchronised with the clocks of the transmitters 14, 16 and 18 via the communication connection to the control and monitoring entity. However, synchronisation of the clocks between transmitter and receiver is unnecessary with this invention, since—as is shown below—the transmission times are eliminated.

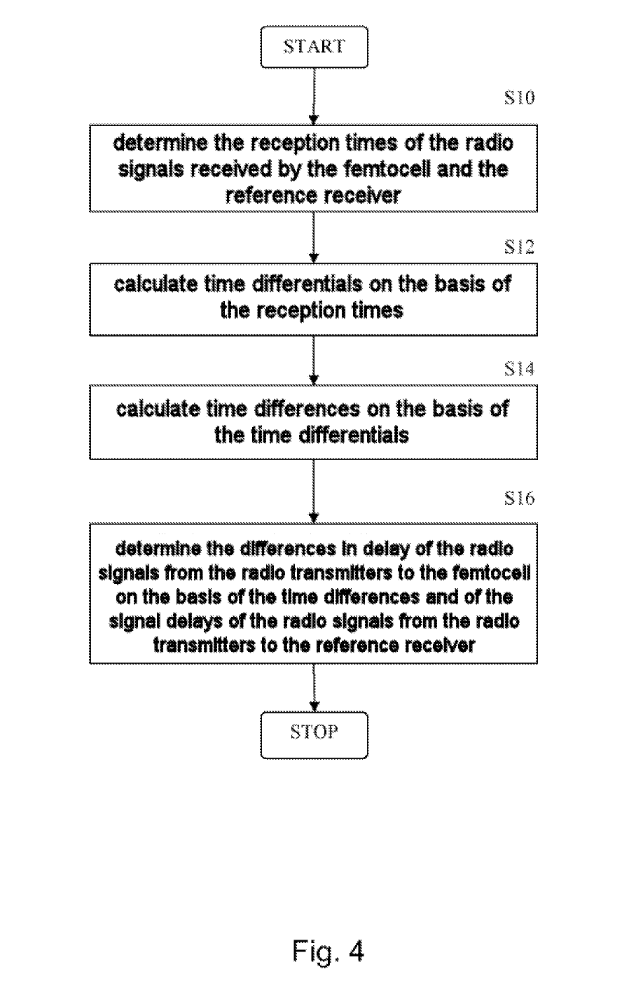

Below, the method according to an exemplary embodiment of the invention is explained in detail and with reference to the flowchart shown in FIG. 4 of an algorithm to implement the method according to an embodiment of the invention.

A radio signal S1 which the transmitter 14 broadcasts at time T₁ reaches the femto-base station 10 after a signal delay t₁, and the reference receiver 12 after a signal delay t₁′. Usually, the clocks of the femto-base station 10 and reference receiver 12 are not synchronised with each other, but have an offset ΔT and ΔT′ respectively. Thus the clocks of the femto-base station 10 and reference receiver 12 show the times T₁ₑ=T₁+t₁+ΔT and T₁ₑ′=T₁+t₁′+ΔT′ respectively (index e means the reception time, and the indices 1, 2, 3 identify the signals S1, S2, and S3 broadcast by the transmitters 14, 16 and 18 respectively) at which the signal which the transmitter 14 broadcasts at time T₁ is received. Similarly, the clocks of the femto-base station 10 and reference receiver 12 show the times T₂ₑ=T₂+t₂+ΔT and T₂ₑ′=T₂+t₂′+ΔT′respectively at which a signal S2 which the transmitter 16 broadcasts at time T₂ is received. In the case of a signal S3 which the transmitter 18 broadcasts at time T₃, the clocks of the femto-base station 10 and reference receiver 12 show the times T₃ₑ=T₃+t₃+ΔT and T₃ₑ′=T₃+t₃′+ΔT′ respectively. Thus in summary, both the femto-base station 10 and the reference receiver capture three reception times T₁ₑ and T₁ₑ′, T₂ₑ and T₂ₑ′ and T₃ₑ and T₃ₑ′ respectively when they receive the radio signals S1, S2 and S3 from the three transmitters 14, 16 and 18 (Step S10).

The femto-base station 10 and reference receiver 12 subtract the captured reception times for the signals broadcast by the transmitters 14, 16 and 18 from each other, to calculate time differentials between the reception signals, i.e. the radio signals of different transmitters to the femto-base station 10 and reference receiver 12 respectively (Step S12). This results in the following time differentials in the femto-base station 10:

T₁ₑ−T₂ₑ=ΔT₁₂=T₁+t₁+ΔT−(T₂+t₂+ΔT)=T₁+t₁−T₂−t₂

T₁ₑ−T₃ₑ=ΔT₁₃=T₁+t₁+ΔT−(T₃+t₃+ΔT)=T₁+t₁−T₃−t₃

T₂ₑ−T₃ₑ=ΔT₂₃=T₂+t₂+ΔT−(T₃+t₃+ΔT)=T₂+t₂−T₃−t₃

In the reference receiver 12, the following time differentials are calculated:

T₁ₑ′−T₂ₑ′=ΔT₁₂′=T₁′+t₁′+ΔT′−(T₂′+t₂′+ΔT′)=T₁′+t₁′−T₂′−t₂′

T₁ₑ′−T₃ₑ′=ΔT₁₃′=T₁′+t₁′+ΔT′−(T₃′+t₃′+ΔT′)=T₁′+t₁′−T₃′−t₃′

T₂ₑ′−T₂ₑ′=ΔT₂₃′=T₂′+t₂′+ΔT′−(T₃′+t₃′+ΔT′)=T₂′+t₂′−T₃′−t₃′

The time differentials ΔT₁₂, ΔT₁₂′, ΔT₁₃, ΔT₁₃′, ΔT₂₃ and ΔT₂₃′ calculated in this way are transmitted by the femto-base station 10 and reference receiver 12 to the control and monitoring entity 20 of the mobile communication network operator for further processing. The effect of the clock offsets ΔT and ΔT′ is eliminated in the time differentials. The time differentials can also be calculated by the control and monitoring entity 20, so that the femtocell 12 and the reference receiver must transmit to the control and monitoring entity only the captured reception times for the signals which the transmitters 14, 16 and 18 broadcast.

The locations of the radio transmitters and reference receiver are known to the control and monitoring entity 20. The signal delays t₁′, t₂′ and t₃′ can be calculated from them. By subtracting the time differentials ΔT₁₂ and ΔT₁₂′, ΔT₁₃ and ΔT₁₃′ and ΔT₂₃ and ΔT₂₃′, and using the signal delays t₁′, t₂′ and t₃′, the following time differences are calculated (Step S14):

ΔT₁₂=ΔT₁₂−ΔT₁₂′=T₁+t₁−T₂−t₂−(T₁+t₁′−T₂−t₂′)=t₁−t₂−(t₁′−t₂′)

ΔT₁₃=ΔT₁₃−ΔT₁₃′=T₁+t₁−T₃−t₃−(T₁+t₁′−T₃−t₃′)=t₁−t₃−(t₁′t₃′)

ΔT₂₃=ΔT₂₃−ΔT₂₃′=T₂+t₂−T₃−t₃−(T₂+t₃′−T₂−t₃′)=t₂−t₃−(t₂′−t₃′)

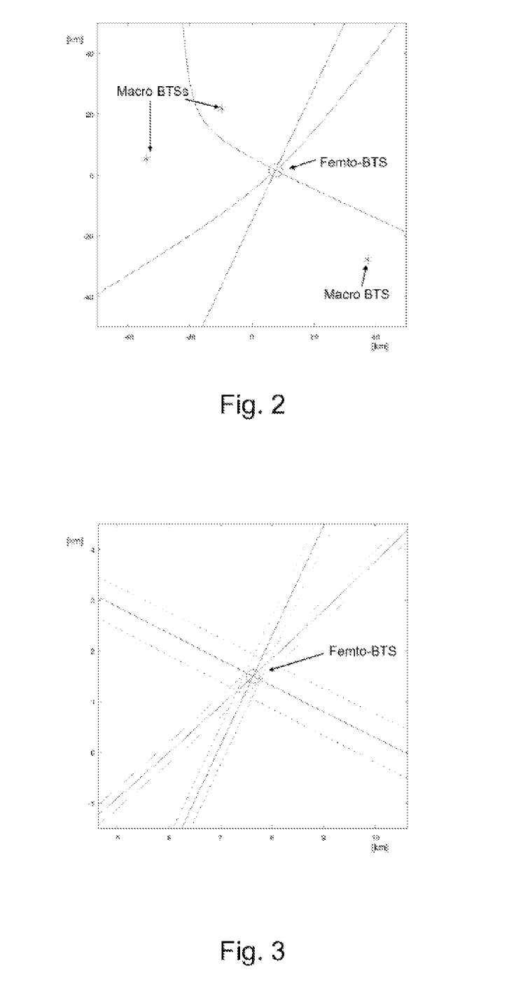

The time differences ΔT₁₂, ΔT₁₃ and ΔT₂₃ depend only on the delay difference t₁−t₂ (or t₁−t₃ or t₂−t₃) of the signals of the radio transmitters to the femto-base station or to the reference receiver, and are independent of the transmission times T₁, T₁ and T₃ and of the clock offsets ΔT and ΔT′. The delay differences t₁−t₂ (or t₁−t₃ or t₂−t₃) of the signals of the radio transmitters to the femto-base station 10 can therefore be determined on the basis of the time differences ΔT₁₂, ΔT₁₃ and ΔT₂₃ and of the signal delays t₁′, t₂′ and t₃′ of the radio signals from the radio transmitters to the reference receiver, said signal delays being determined on the basis of the known location of the reference receiver 12 and of the known locations of the transmitters of the radio signals (Step S16). Assuming that the radio signals are propagated on the direct path (“line of sight”), all geographical locations with the same delay difference t₁−t₂ (or t₁−t₃ or t₂−t₃) form a hyperbola. That is, the position of the femto-base station 10 is on a hyperbola which is uniquely determined by the delay difference t₁−t₂ (or t₁−t₃ or t₂−t₃). In reality, reflections and propagation along multiple paths will result in deviation from this ideal hyperbola, and thus reduced positioning precision. The sought location of the femto-base station is given as the intersection of all three hyperbolas, as shown in FIG. 2.

The control and monitoring entity 20 checks whether the actual location of the femto-base station 10, corresponding to the measured values of the femto-base station 10, agrees sufficiently precisely with a planned location (or one of several permitted locations). If it is established by this comparison that the femto-base station 10 is at the planned location, the control and monitoring entity 20 of the mobile communication provider grants the femto-base station 10 permission to act as an active mobile communication cell, by the control and monitoring entity 20 transmitting to the femto-base station 10 the above-mentioned encrypted enabling code.

Only after receiving this permission, the active radio part of the femto-base station 10 is switched on, as are the femtocell and an active part of the mobile communication provision. If the acknowledgment by the control and monitoring entity 20 of the mobile communication provider is negative, this acknowledgment does not occur, or the femto-base station 10 cannot receive any suitable radio transmitters and thus calculate time differentials and transmit them to the control and monitoring entity 20, the femto-base station cannot be activated.

To ensure that an active femto-base station remains at its intended location and cannot be moved away from it, the described method for location checking is repeated at arbitrary intervals. For example, location checking according to this invention can take place several times a day, hourly or, for example, every 10 minutes. For example, the enabling code which the control and monitoring entity 20 transmits can have time-limited validity, so that the femtocell 10, after the validity of the enabling code expires, must again initiate location checking by the method according to the invention, to obtain a new enabling code to activate its radio part. It is also conceivable that the femtocell repeats a location check by the method according to the invention at arbitrary time intervals, and if the determined location differs too greatly from the intended location(s) for the femtocell, the radio part of the femtocell is automatically switched off by the control and monitoring entity transmitting an appropriate deactivation code.

The precision of the method according to the invention depends above all on how precisely the delay differences t₁−t₂, t₁−t₃ and t₂−t₃ can be measured. For example, if the tolerance range of these measurements is ±0.5 μs, instead of a hyperbola line the result is a hyperbola strip of at least 3·10⁸ m/s×1 μs=300 m (since radio signals are propagated at the speed of light, i.e. 3·10⁸ m/s). With increasing distance from the radio transmitters, this strip width becomes larger. FIG. 3 is a section from FIG. 2, and shows the different widths of these strips.

The time differences ΔT₁₂, ΔT₁₂′, ΔT₁₃, ΔT₁₃′, ΔT₂₃ and ΔT₂₃′ can be calculated in the network operator's control and monitoring entity 20 instead of in the femto-base station 10 and reference receiver 12. In this case, the femto-base station 10 and reference receiver 12 must report their local times, at which they have received the signals which the transmitters 14, 16 and 18 broadcast at times T₁, T₂ and T₃, to the control and monitoring entity 20. This then proceeds as described above.

It is also possible to do without the control and monitoring entity 20, so that the femtocell can activate its radio part autonomously. For this purpose, the measured values of the reference receiver 12 are sent to the femto-base station 10 which is to be located, as indicated in FIG. 1 by the dashed line. Then all the steps described above can be carried out in the femto-base station 10 by the method according to the invention. In this implementation, the femto-base station 10 is only permitted to activate its radio part if it itself establishes that it is at the planned (or a permitted) location. The method according to the invention for processing the measured values, and the location checking which depends on it, can for example be implemented as part of the firmware of the femtocell.

A femto-base station can also be used as the reference receiver. For this purpose, this reference femto-base station can be fitted at a known location, e.g. a macro-base station. The reference femto-base station uses the same method as the femto-base station to be located. However, the reference femto-base station does not have to be activated for this purpose by the control and monitoring entity.

A further increase in the precision of the location check is possible if the signals from more than three radio transmitters are evaluated.

The method according to an embodiment of the invention can also be combined with other methods for determining the location according to the prior art described above. For example, the femto-base station could first orient itself on macrocells of a mobile communication network, if it can receive them, since these reliably ensure high location precision. If no radio signal can be received from a macro-base station, the femto-base station can, for example, orient itself on freely receivable broadcast transmitters, according to the method described here. Finally, the location can be further determined by determining the physical broadband connection to which the femto-base station is connected. Compared with the previous location determination based on macro-base stations and other radio transmitters, the possibility of tampering as described in the introduction has little prospect of success and is thus unattractive for location by means of the broadband connection. In a variant of this combined method, a femto-base station, which can determine its own location with sufficient precision by receiving radio signals from one or more macro-base stations, can act additionally as a reference receiver for checking the location of other femto-base stations by the method according to the invention described above. The location of this femto-base station itself can be determined on the basis of the macro-base stations, and the result is communicated to the control and monitoring entity. Additionally, this femto-base station can determine the identities and time differentials of the broadcast or television transmitters it can receive, and also report these data to the control and monitoring entity. The control and monitoring entity can use these time differentials, in association with the known location of the femto-base station, as the reference for checking the location of other femto-base stations. In this way, femto-base stations which are operated by mobile communication customers can also act as reference receivers, and the mobile communication network operator can do without its own reference receivers or reference femto-base stations.

With the invention, checking the location of a femtocell, and in particular enabling the operation of a femtocell, can be improved by a mobile communication provider, in particular in areas which are under-supplied with mobile communications.

While the invention has been described with reference to particular embodiments thereof, it will be understood by those having ordinary skill the art that various changes may be made therein without departing from the scope and spirit of the invention. Further, the present invention is not limited to the embodiments described herein; reference should be had to the appended claims.

### REFERENCE SYMBOLS

10 femto-base station or femtocell
12 reference receiver
14, 16, 18 transmitters for radio signals
20 control and monitoring entity of a mobile communication network

1-18. (canceled)

19. A method for checking the location of a femtocell, comprising:
receiving, by the femtocell and by a reference receiver having a known location, radio signals from at least three transmitters disposed at known locations, wherein each of the transmitters is at least one of a broadcast transmitter and a pilot radio signal transmitter configured to broadcast a pilot radio signal for checking the location of the femtocell in a frequency range outside frequency ranges used for mobile communication;
determining differences in delay of the radio signals from two of the at least three transmitters based on reception times of the radio signals received by the femtocell and the reference receiver; and
checking the location of the femtocell based on the determined differences in delay.

20. The method according to claim 19, wherein the determining differences in delay of the radio signals comprises:
determining the reception times of the radio signals received by the femtocell and the reference receiver;
calculating time differentials based on the reception times;
calculating time differences based on the time differentials; and
determining the differences in delay of the radio signals from the radio transmitters to the femtocell based on the time differences and signal delays of the radio signals from the at least three transmitters to the reference receiver, the signal delays being determined based on the known location of the reference receiver and the known locations of the at least three transmitters.

21. The method according to claim 20, wherein the checking the location of the femtocell based on the determined differences in delay comprises:
forming the time differences based on the calculated time differentials using the radio signals of the at least three transmitters, two of the time differentials being determined based on the reception times of the radio signals broadcast by the two of the at least three transmitters and received once by the femtocell and once by the reference receiver;
determining distance ranges, associated with the formed time differences, to the at least three transmitters; and
checking the location of the femtocell based on the determined distance ranges.

22. The method according to claim 21, wherein the checking the location of the femtocell based on the determined distance ranges comprises:
determining an overlap area of the determined distance ranges as an area for possible locations of the femtocell, and
checking the location of the femtocell based on the overlap area.

23. The method according to claim 19, wherein the determining the differences in delay of the radio signals from the two of the at least three transmitters and the checking the location of the femtocell based on the determined differences in delay are performed by a control and monitoring entity of a mobile communication network, time differentials being determined based on the reception times of the radio signals received by the femtocell and the reference receiver, the time differentials being communicated by the femtocell and the reference receiver to the control and monitoring entity so as to check the location of the femtocell.

24. The method according to claim 19, wherein the determining the differences in delay of the radio signals from the two of the at least three transmitters and the checking the location of the femtocell based on the determined differences in delay are performed by a control and monitoring entity of a mobile communication network, local reception times of the radio signals being communicated by the femtocell and the reference receiver to the control and monitoring entity.

25. The method according to claim 19, wherein the determining the differences in delay of the radio signals from the two of the at least three transmitters and the checking the location of the femtocell based on the determined differences in delay are performed by the femtocell, time differentials being determined based on the reception times of the radio signals received by the reference receiver and communicated by the reference receiver to the femtocell so as to check the location of the femtocell.

26. The method according to claim 19, wherein the determining the differences in delay of the radio signals from the two of the at least three transmitters and the checking the location of the femtocell based on the determined differences in delay are performed by the femtocell, reception times of the radio signals received by the reference receiver being determined by the reference receiver and communicated to the femtocell so as to check the location of the femtocell.

27. The method according to claim 19, further comprising:
determining whether the location of the femtocell corresponds to at least one planned location of the femtocell, and
activating, based on the determining whether the location of the femtocell corresponds to at least one planned location of the femtocell, a provision of mobile communications by the femtocell within an area covered by the femtocell.

28. The method according to claim 27, wherein the activating the provision of mobile communication is performed if the location of the femtocell corresponds to the at least one planned location of the femtocell.

29. The method according to claim 19, wherein the receiving, determining and checking steps are cyclically repeated.

30. The method according to claim 19, wherein the reference receiver is configured as a reference femtocell having the known location of the reference receiver.

31. The method according to claim 30, wherein the reference receiver is disposed at a macro-base station of a mobile communication network.

32. The method according to claim 31, wherein the reference receiver is fitted at the macro-base station.

33. A femtocell configured to receive radio signals from at least three transmitters disposed at known locations, wherein each of the transmitters is at least one of a broadcast transmitter and a pilot radio signal transmitter configured to broadcast a pilot radio signal so as to check a location of the femtocell, in a frequency range outside frequency ranges used for mobile communication, based on differences in delay of the radio signals from two of the at least three transmitters.

34. The femtocell according to claim 33, wherein the femtocell is further configured to determine the differences in delay of the radio signals from two of the at least three transmitters.

35. The femtocell according to claim 33, wherein the femtocell is further configured to at least one of:
transmit time differentials between reception times of the received radio signals to a control and monitoring entity of a mobile communication network; and
transmit local reception times of radio signals to the control and monitoring entity.

36. The femtocell according to claim 34, wherein the femtocell is further configured to:
receive at least one of reception times of the radio signals and time differentials, wherein the receptions times of the radio signals are measured by a reference receiver and the time differentials are determinable based on the reception times; and
check the location of the femtocell based on the determined differences in delay.

37. The femtocell according to claim 36, wherein the femtocell is further configured to:
determine whether the location of the femtocell corresponds to at least one planned location of the femtocell; and
activate, based on the determination whether the location of the femtocell corresponds to at least one planned location of the femtocell, a provision of mobile communication within an area covered by the femtocell.

38. A control and monitoring entity of a mobile communication network configured to communicate with a femtocell and a reference receiver which receive radio signals from at least three transmitters disposed at known locations and determine differences in delay of the radio signals from two of the at least three transmitters so as to check a location of the femtocell and, based on the check, the control and monitoring entity is further configured to communicate to the femtocell an enabling code to activate a radio part of the femtocell.
